(19) United States
(12) Patent Application Publication
(10) Pub. No.: US 2015/0082186 A1
(43) Pub. Date: Mar. 19, 2015

(54) CUSTOMIZED INTERFACE SYSTEM AND OPERATING METHOD THEREOF

(71) Applicant: Hyundai Motor Company, Seoul (KR)

(72) Inventors: Seung Hyun Woo, Seoul (KR); Gi Beom Hong, Bucheon (KR); Suhong Chae, Hwaseong (KR); Daeyun An, Anyang (KR)

(21) Appl. No.: 14/340,671

(22) Filed: Jul. 25, 2014

(30) Foreign Application Priority Data
Sep. 13, 2013 (KR) 10-2013-0110668

(51) Int. Cl. G06F 3/0484; G06K 9/00; G06F 3/01; G06F 3/0488

(52) U.S. Cl. CPC G06F 3/04845; G06F 3/0488; G06K 9/00362; G06F 3/017; G06K 2009/00395
USPC 715/747

(57) ABSTRACT

An operating method and system of a customized interface system are provided. The method includes setting, by a controller, a plurality of manipulation regions in a customized input interface and mapping a first manipulation region among the plurality of manipulation regions to a first function among a plurality of functions provided from an information technology (IT) device. In addition, the controller is configured to recognize a user's finger based on an image photographed by an imaging device and execute the first function when a position of the user's finger corresponds to the first manipulation region.

### CROSS-REFERENCE TO RELATED APPLICATION

This application claims priority to and the benefit of Korean Patent Application No. 10-2013-0110668 filed in the Korean Intellectual Property Office on Sep. 13, 2013, the entire contents of which are incorporated herein by reference.

### BACKGROUND

(a) Field of the Invention

The present invention relates to a customized interface system and an operating method thereof.

(b) Description of the Related Art

With the development of electronic technology, a touch screen has been used as a user interface for various information technology (IT) devices. In particular, for a touch screen, since the user interface preset by a manufacturing company of the IT devices is provided to a user as it is and is unable to be customized, it may be difficult to provide an optimal interface to the user.

The above information disclosed in this section is merely for enhancement of understanding of the background of the invention and therefore it may contain information that does not form the prior art that is already known in this country to a person of ordinary skill in the art.

### SUMMARY

The present invention provides a customized interface system and an operating method thereof having advantages of enabling interfacing with an information technology device using an input interface created (e.g. customized) by a user.

An operating method of a customized interface system may include: setting a plurality of manipulation regions in an input interface created by a user (e.g., in a customized input interface); mapping a first manipulation region among the plurality of manipulation regions to a first function among a plurality of functions provided from an information technology (IT) device; recognizing a user's finger or an object based on an image that is photographed by an imaging device (e.g., a camera, a video camera, etc.); and executing the first function when a position of the user's finger or the object corresponds to the first manipulation region.

The operating method may further include: mapping a second manipulation region among the plurality of manipulation regions to a second function among the plurality of functions provided by the IT device; and executing the second function when a user's hand gesture or the gesture of the object corresponding to the second manipulation regions is recognized. The input interface may be any one of an image, a picture, a hand drawing, and a three-dimensional shape of specific hardware.

A customized interface system according to an exemplary embodiment of the present invention may include: an imaging device configured to capture an input interface created by a user; and a controller configured to set a plurality of manipulation regions in the input interface, and map a first manipulation region among the plurality of manipulation regions to a first function among a plurality of functions provided from an information technology (IT) device, wherein the controller may be configured to recognize a user's finger or an object (e.g., a pen or the like) based on an image captured by the imaging device, and execute the first function when a position of the user's finger or object corresponds to the first manipulation region.

The controller may be configured to map a second manipulation region among the plurality of manipulation regions to a second function among the plurality of functions provided by the IT device, and execute the second function when a user's hand gesture or the gesture of the object corresponding to the second manipulation regions is recognized. The input interface may be any one of an image, a picture, a hand drawing, and a three-dimensional shape of specific hardware.

According to an exemplary embodiment of the present invention, the customized interface system may be installed within a vehicle. The function corresponding to the manipulation region or the hand gesture may be executed by recognizing the finger or the hand gesture when the user such as a driver points at the input interface with the finger (e.g., an object, or any other pointing device) or performs the hand gesture. Since the optimal input interface may be created and customized by the user, the user may intuitively interface with the IT device. In addition, the input interface applied within the vehicle may be tested before the input interface is mounted within the vehicle.

### BRIEF DESCRIPTION OF THE DRAWINGS

FIG. 1 is an exemplary diagram illustrating a customized interface system according to an exemplary embodiment of the present invention;

FIG. 2 is an exemplary flowchart of a method for realizing a customized interface system according to an exemplary embodiment of the present invention; and

FIG. 3 is an exemplary flowchart of an operating method of a customized interface system according to an exemplary embodiment of the present invention.

### DETAILED DESCRIPTION

It is understood that the term “vehicle” or“vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, “module”, and “block” described in the specification mean units for processing at least one function and operation, and can be implemented by hardware components or software components and combinations thereof.

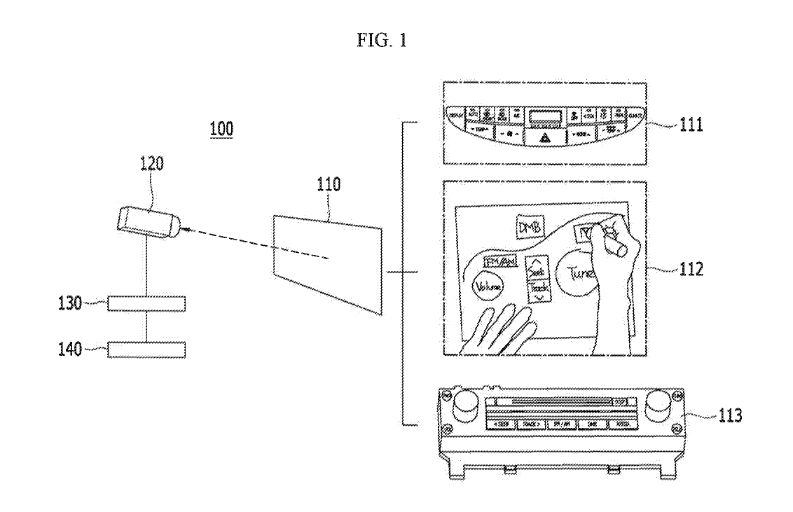

FIG. 1 is an exemplary diagram of a customized interface system according to an exemplary embodiment of the present invention. Referring to FIG. 1, a customized interface system 100 according to an exemplary embodiment of the present invention may include an input interface 110, an imaging device 120, and a controller 130.

The input interface 110 may be an interface created (e.g., customized) by a user. The input interface 110 may be an image or a picture 111, or a hand drawing 112 drawn by a pen or the like. Further, the input interface 110 may be a three-dimensional shape 113 of specific hardware for the user to obtain operation feeling. The imaging device 120 may be configured to photograph the input interface 110 and output a photographed image to the controller 130. The controller 130 may be connected to the imaging device 120, and may be implemented with one or more microprocessors executed by a predetermined program. The predetermined program may include a series of commands for performing each step included in an operating method of the customized interface system 100 according to an exemplary embodiment of the present invention.

The controller 130 may be configured to recognize the input interface 110 based on the photographed image. The controller 130 may be configured to divide regions of the input interface 110 and set a plurality of manipulation regions. Various functions (e.g., volume control or channel selection of an audio video navigation device) provided from an information technology (IT) device 140 may be mapped to the plurality of manipulation regions. The controller 130 may also be configured to recognize a position of a user's finger or a user's hand gesture or an object position. The controller 130 may be configured to execute a function mapped to a manipulation region corresponding to the position of the user's finger or the object, or execute a function that corresponds to the user's hand gesture.

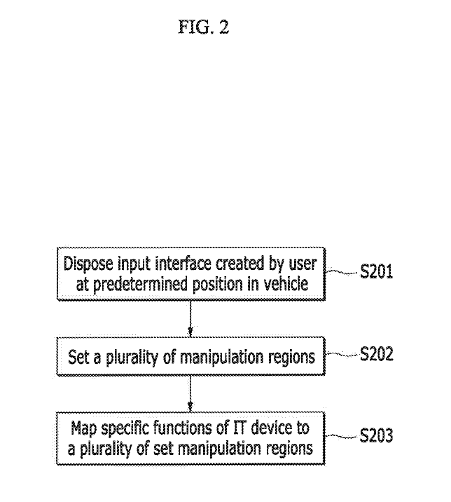

FIG. 2 is an exemplary flowchart of a method for realizing a customized interface system according to an exemplary embodiment of the present invention. Referring to FIG. 2, the input interface 110 created by the user may be disposed at a predetermined position in a vehicle at step S201. The controller 130 may be configured to set the plurality of manipulation regions in the input interface 110 at step S202. In other words, the controller 130 may be configured to recognize the input interface 110 using the imaging device 120, and set the plurality of manipulation regions in the input interface 110.

Furthermore, the controller 130 may be configured to map specific functions of the IT device 140 to the plurality of set manipulation regions at step S203. For example, when the three-dimensional shape 113 of the specific hardware is created as the input interface 110, the specific functions of the IT device 140 may be mapped to the plurality of manipulation regions of the three-dimensional shape 113, for one of the specific functions to be executed when the position of the user's finger or the object position corresponds to one of the plurality of manipulation regions.

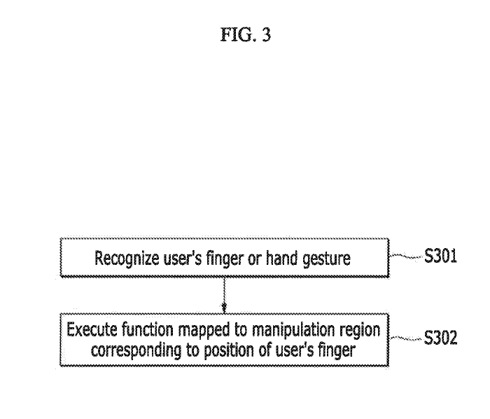

FIG. 3 is an exemplary flowchart of an operating method of a customized interface system according to an exemplary embodiment of the present invention. Referring to FIG. 3, when the user's finger approaches the input interface 110, the controller 130 may be configured to recognize the user's finger based on the image photographed by the imaging device 120 at step S301. In particular, the controller 130 may be configured to recognize the user's hand gesture.

Further, the controller 130 may be configured to execute a function mapped to the manipulation region that corresponds to the position of the user's finger or the object position, and provide feedback on the manipulation to the user at step S302. The customized interface system 100 according to an exemplary embodiment of the present invention may be installed within the vehicle. The function corresponding to the manipulation region or the hand gesture may be executed by recognizing the finger or the hand gesture when the user such as a driver points at the input interface 110 with the finger (e.g., an object) or performs the hand gesture. According to an exemplary embodiment of the present invention, since the optimal input interface 110 may be created (e.g., a customized input interface 110) by the user, the user may intuitively interface with the IT device 140. In addition, the input interface 110 to be applied within the vehicle may be tested before the input interface 110 is mounted within the vehicle.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the accompanying claims.

What is claimed is:

1. An operating method of a customized interface system, comprising:
setting, by a controller, a plurality of manipulation regions in a customized input interface;
mapping, by the controller, a first manipulation region among the plurality of manipulation regions to a first function among a plurality of functions provided from an information technology (IT) device;
recognizing, by the controller, a user's finger based on an image photographed by an imaging device; and
executing, by the controller, the first function when a position of the user's finger corresponds to the first manipulation region.

2. The operating method of claim 1, further comprising:
mapping, by the controller, a second manipulation region among the plurality of manipulation regions to a second function among the plurality of functions provided by the IT device; and
executing, by the controller, the second function when a user's hand gesture that corresponds to the second manipulation region is recognized.

3. The operating method of claim 1, wherein the input interface is any one selected from a group consisting of: an image, a picture, a hand drawing, and a three-dimensional shape of specific hardware.

4. A customized interface system comprising:
an imaging device configured to photograph a customized input interface by a user; and
a controller configured to:
set a plurality of manipulation regions in the input interface;
map a first manipulation region among the plurality of manipulation regions to a first function among a plurality of function provided from an information technology (IT) device;
recognize a user's finger based on an image photographed by the imaging device; and
execute the first function when a position of the user's finger corresponds to the first manipulation region.

5. The customized interface system of claim 4, wherein the controller further configured to:
map a second manipulation region among the plurality of manipulation regions to a second function among the plurality of functions provided by the IT device; and
execute the second function when a user's hand gesture that corresponds to the second manipulation region is recognized.

6. The customized interface system of claim 4, wherein the input interface is any one selected from a group consisting of: an image, a picture, a hand drawing, and a three-dimensional shape of specific hardware.

7. A non-transitory computer readable medium containing program instructions executed by a processor or controller, the computer readable medium comprising:
program instructions that set a plurality of manipulation regions in a customized input interface;
program instructions that map a first manipulation region among the plurality of manipulation regions to a first function among a plurality of functions provided from an information technology (IT) device;
program instructions that recognize a user's finger based on an image photographed by an imaging device; and
program instructions that execute the first function when a position of the user's finger corresponds to the first manipulation region.

8. The non-transitory computer readable medium of claim 7, further comprising:
program instructions that map a second manipulation region among the plurality of manipulation regions to a second function among the plurality of functions provided by the IT device; and
program instructions that execute the second function when a user's hand gesture that corresponds to the second manipulation region is recognized.

9. The non-transitory computer readable medium of claim 7, wherein the input interface is any one selected from a group consisting of: an image, a picture, a hand drawing, and a three-dimensional shape of specific hardware.
